(19) United States
(12) Patent Application Publication
(10) Pub. No.: US 2009/0011210 A1
(43) Pub. Date: Jan. 8, 2009

(54) Lightweight glass fiber reinforced thermoplastic material

(76) Inventors: Xiao Gao, Lynchburg, VA (US); Thomas Arnold Ebeling, Forest, VA (US); Brian Hynes, Huntersville, NC (US); Scott Davis, Great Barrington, MA (US); Thomas Wood, Shelby, NC (US); Josephus Theorodus Petrus Dictus, Bergen Op Zoom (NL); Thomas Arnold Ebeling, Southfield, MI (US)

Correspondence Address: MARK L. WARZEL, 10252 OVERHILL DRIVE, SANTA ANA, CA, 92705, US

(21) Appl. No.: 12/070,372

(22) Filed: Feb. 15, 2008

Related U.S. Application Data
(60) Provisional application No. 60/902,019, filed on Feb. 15, 2007.

(51) Int. Cl. B32B 5/00; B32B 37/00; B32B 38/00

(52) U.S. Cl. 428/220; 156/60; 156/244.27

(57) ABSTRACT

A glass fiber reinforced thermoplastic sheet material is provided in which certain properties, or combinations of properties, are improved relative to similar comparative sheet materials. The sheet material generally comprises a glass mat or glass fabric fiber reinforced thermoplastic resin in which the thermoplastic resin at least partially impregnates the glass mat or fabric. The thermoplastic sheet material contains about 15 wt. % to about 65 wt. % of the glass mat or fabric based on the weight of the thermoplastic sheet material and has a thickness in the range of about 0.4 mm to about 3.0 mm. By including glass mat or fabric and maintaining the sheet thickness in the aforementioned range, the present invention thermoplastic sheet material exhibits improved flexural and/or tensile strength and modulus properties at reduced basis weight compared to a comparative thermoplastic sheet materials. A method of providing the glass fiber reinforced thermoplastic sheet material having an improved combination of flexural strength and modulus and/or tensile strength and modulus properties is also described, in which a first layer of a first thermoplastic resin, a second layer of a second thermoplastic resin, and a layer of glass mat or glass fabric are provided; the first thermoplastic resin layer, the second thermoplastic resin layer and the glass mat or glass fabric layer are arranged such that the glass mat or glass fabric layer is interposed between the first and second thermoplastic resin layers; and heat and pressure are applied to substantially melt and compress the first thermoplastic resin and/or the second thermoplastic resin and to at least partially impregnate the glass mat or glass fabric layer with the molten first thermoplastic resin and/or the molten second thermoplastic resin.

### CROSS REFERENCE TO RELATED APPLICATIONS

This application claims priority under 35 U.S.C. §119(e)(1) to U.S. Provisional Application No. 60/902,019, filed Feb. 15, 2007, which is hereby incorporated by reference in its entirety.

### FIELD OF THE INVENTION

The present invention relates to glass fiber reinforced thermoplastic materials, the use of such materials to form articles, and to improvements in certain characteristics of those materials and articles. More particularly, the invention relates to glass fiber reinforced thermoplastic sheet materials, and composites and articles formed therefrom, having a beneficial combination of characteristics wherein the sheet material exhibits improved mechanical properties, such as tensile and flexural properties, while maintaining or improving other desirable characteristics, such as reduced basis weight.

Although not limited thereto, the invention is useful in the manufacture of a variety of articles, such as in building infrastructure, construction, and aerospace, marine and automotive articles, including end-use applications that are currently made with other materials and thermoformable thermoplastic sheets, in which the improved performance and characteristics of the present invention materials provide advantages over such other materials.

### BACKGROUND OF THE INVENTION

Driven by a growing demand by industry, governmental regulatory agencies and consumers for durable and inexpensive products that are functionally comparable or superior to metal products, a continuing need exists for improvements in composite articles subjected to difficult service conditions. This is particularly true in the automotive industry where developers and manufacturers of articles for automotive and construction materials applications must meet a number of competing and stringent performance specifications for such articles.

In an effort to address these demands, a number of composite materials have been developed, including glass fiber reinforced thermoplastic sheet materials. Such composites provide a number of advantages, e.g., they can be molded and formed into a variety of suitable products both structural and non-structural. Traditional glass fiber composites used in exterior structural applications are generally compression flow molded and are substantially void free in their final part shape. By comparison, low density glass fiber composites used in automotive interior applications are generally semi-structural in nature and are porous and light weight with densities ranging from 0.1 to 1.8 g/cm³ and containing 5% to 95% voids distributed uniformly through the thickness of the finished part. The stringent requirements for certain automotive interior applications have been difficult to meet, however, for existing glass fiber composite products, particularly where such applications require a desirable combination of properties, such as light weight, good flexural properties or rigidity and good strength characteristics. As a result, a continuing need exists to provide further improvements in the ability of composite materials to meet such performance standards.

Fiber reinforced thermoplastic sheets have been described in numerous U.S. patents, e.g., U.S. Pat Nos. 4,978,489 and 4,670,331, and are well known to be useful in varied applications in the product manufacturing industry because of the ease of molding the fiber reinforced thermoplastic sheets into articles. Known techniques, for example, thermo-stamping, compression molding, and thermoforming, have been used to successfully form articles from fiber reinforced thermoplastic sheets.

In some industries, e.g., the automotive industry, a need also exists for products formed from fiber reinforced thermoplastic sheets that have higher flexural properties than known products. In automotive headliner and sunshade substrate applications, the balance of weight and part stiffness is an important concern due to the desire to minimize weight while maintaining the stiffness required for the part application. The ability to achieve improved property performance at reduced basis weight would consequently provide a significant advantage over fiber reinforced thermoplastic composite materials currently in use.

### BRIEF DESCRIPTION OF THE INVENTION

Accordingly, in one aspect of the invention, a glass fiber reinforced thermoplastic sheet material is provided in which certain properties, or combinations of properties, are improved relative to similar comparative glass fiber reinforced sheet materials. The thermoplastic sheet material generally comprises a glass mat or glass fabric fiber reinforced thermoplastic resin in which the thermoplastic resin at least partially impregnates the glass mat or fabric. The thermoplastic sheet material contains about 15 wt. % to about 65 wt. % of the glass mat or fabric based on the weight of the thermoplastic sheet material and has a thickness in the range of about 0.4 mm to about 3.0 mm. By including glass mat or fabric and maintaining the sheet thickness in the aforementioned range, the present invention thermoplastic sheet material exhibits improved flexural and/or tensile strength and modulus properties at reduced basis weight compared to a comparative thermoplastic sheet material having a thickness of greater than about 3.0 mm.

In another aspect of the invention, a method of providing a glass fiber reinforced thermoplastic sheet material having an improved combination of flexural strength and modulus and/or tensile strength and modulus properties is described. The method includes providing a first layer of a first thermoplastic resin and a second layer of a second thermoplastic resin; providing a layer of glass mat or glass fabric; arranging the first thermoplastic resin layer, the second thermoplastic resin layer and the glass mat or glass fabric layer such that the glass mat or glass fabric layer is interposed between the first and second thermoplastic resin layers, thereby forming a thermoplastic sheet material perform; applying heat to substantially melt the first thermoplastic resin and/or the second thermoplastic resin; applying pressure to compress the preform and at least partially impregnate the glass mat or glass fabric layer with the molten first thermoplastic resin and/or the molten second thermoplastic resin and to form a glass fiber reinforced thermoplastic sheet material having a thickness in the range of about 0.4 mm to about 3.0 mm. The method provides a glass fiber reinforced thermoplastic sheet material exhibiting an improved combination of flexural strength and modulus and/or tensile strength and modulus properties at reduced basis weight compared to a comparative composite material having a thickness of greater than about 3.0 mm.

### BRIEF DESCRIPTION OF THE DRAWINGS

FIG. 1 depicts experimental flexural strength results according to ISO 178 as described in the Examples.

FIG. 2 depicts experimental flexural modulus results according to ISO 178 as described in the Examples.

FIG. 3 depicts experimental flexural strength results according to ASTM D790 as described in the Examples.

FIG. 4 depicts experimental flexural modulus results according to ASTM D790 as described in the Examples.

FIG. 5 depicts experimental tensile strength results according to ISO 527 as described in the Examples.

FIG. 6 depicts experimental tensile modulus results according to ISO 527 as described in the Examples.

FIG. 7 depicts experimental impact energy results according to ASTM D3762 as described in the Examples.

### DETAILED DESCRIPTION OF THE INVENTION

As used in the specification and the appended claims, the singular forms “a,” “an,” and “the” include plural referents unless the context clearly dictates otherwise. Thus, for example, reference to “a thermoplastic resin” encompasses a combination or mixture of different resins as well as a single resin, reference to “a skin layer” or “a surface layer” includes a single layer as well as two or more layers that may or may not be the same and may be on one or more sides or surfaces of the thermoplastic sheet material, and the like.

As used herein, the term “about” is intended to permit some variation in the precise numerical values or ranges specified. While the amount of the variation may depend on the particular parameter, as used herein, the percentage of the variation is typically no more than 5%, more particularly 3%, and still more particularly 1% of the numerical values or ranges specified. When used to modify particular numerical values or ranges, the phrases “greater than about” or “less than about” refer to amounts or ranges that are respectively greater than or less than the amounts or ranges encompassed by the term “about”.

In this specification and in the claims that follow, reference is also made to a certain terms, which shall be defined to have the following meanings:

The term “basis weight” generally refers to the areal density of a fiber reinforced thermoplastic material, typically expressed in grams per square meter (g/m² or gsm) of the material in sheet form. The term “reduced basis weight” refers to a reduction in the basis weight that may be realized for materials according to the invention relative to a comparative material. As used herein, the “comparative glass fiber reinforced thermoplastic sheet material” differs from the inventive material at least in one characteristic of the thermoplastic sheet material, such as sheet thickness.

The terms “flexural strength” and “flexural modulus” refer to the conventional measure of the resistance of a material to deformation under load, typically measured according to standard test procedures. Flexural testing was performed according to the ASTM D790 or the ISO 178 test procedures to determine the flexural peak load and modulus by subjecting samples to a three-point bending test (as described in greater detail in the Experimental section).

The terms “tensile strength” and “tensile modulus” refer to results obtained according the ASTM D638 test procedure for Type I specimens, or ISO 527 where indicated.

The term “fabric” as used herein denotes a two- or possibly three-dimensional product built up from oriented fibers. These fibers may occur in the fabric uni-directionally (uni-directional thread as warp with an occasional woof thread), bi-directionally with different warp and woof ratios, or tri-directionally. The term “mat” generally refers to random filaments of fibers of relatively short length pressed into a sheet.

In general, the glass fiber reinforced sheet material of the invention includes a thermoplastic resin and glass fiber mat or fabric impregnated at least partially with the thermoplastic resin. One or more skin layers may also be included on the surface of the thermoplastic sheet material, depending on the needs of the application. The glass mat or fabric is contained within the thermoplastic in an amount of about 15 wt. % to about 65 wt. % of the glass fiber reinforced thermoplastic sheet material, which has a thickness in the range of about 0.4 mm to about 3.0 mm. By including glass mat or fabric and providing a thermoplastic sheet material meeting these characteristics, the present invention exhibits improved flexural and/or tensile strength and modulus properties at reduced basis weight compared to a comparative glass fiber reinforced thermoplastic sheet material having a sheet thickness of greater than about 3.0 mm.

In other aspects of the invention, the glass fiber reinforced thermoplastic sheet material exhibits flexural strength and/or flexural modulus properties that are each at least about 10% greater than the comparative glass fiber reinforced thermoplastic sheet material, more particularly at least about 20% greater than the comparative sheet material.

In still other aspects of the invention, the glass fiber reinforced thermoplastic sheet material exhibits tensile strength and/or tensile modulus properties that are each at least about 10% greater than the comparative glass fiber reinforced thermoplastic sheet material, more particularly at least about 15% greater than the comparative sheet material.

Although the flexural and tensile property advantages realized by the invention may be obtained at reduced basis weight, the invention also includes the aspect wherein the basis weight of the sheet material is about the same as the comparative sheet material described herein. Nonetheless, in some aspects of the invention, the reduced basis weight of the sheet material may be advantageously at least about 30% less than the comparative sheet material described herein, more particularly at least about 50% less than the comparative sheet material, and still more particularly at least about 70% less than the comparative sheet material.

The glass fiber reinforced thermoplastic sheet material as described herein generally has a thickness in the range of about 0.4 mm to about 3.0 mm, more particularly from about 0.4 to about 2.2 mm or about 0.8 mm to about 3.0 mm, and still more particularly from about 0.8 mm to about 2.2 mm. The glass fiber mat or fabric content contained within the thermoplastic resin is generally in the range of about 15 wt. % to about 65 wt. %, more particularly from about 30 wt. % to about 50 wt. %, or about 35 wt. % to about 55 wt. %, of the glass fiber reinforced thermoplastic sheet material.

As described herein, the thermoplastic sheet material, and composite articles formed therefrom, may be non-porous or porous. Advantageously, the porosity may be between about 0% to about 95% by volume of the thermoplastic sheet material, more particularly between about 10% to about 60% by volume of the thermoplastic sheet material.

While not required, it is also possible that a composite material, which includes, or is formed from, the thermoplastic sheet material, is non-porous or has a porosity within the aforementioned ranges; i.e., the porosity of the composite material may vary between about 0% and about 95%, more particularly between about 10% and about 60% of the total volume of the composite material.

The thermoplastic resin may generally be any thermoplastic resin having a melt temperature below the resin degradation temperature. Non-limiting examples of such resins include polyolefins such as polyethylene and polypropylene, thermoplastic polyolefin blends, polyvinyl polymers such as polyvinylalcohol (PVA), polyvinylacetate (PVAc), ehtylenevinylacetate copolymer (EVA), poly-vinylchloride (PVC), polyvinylidenechloride (PVDC), copolymers of vinylchloride and vinylidenechloride or polyvinylidenefluoride (PVDF or PVF2), diene polymers such as polybutadiene, polyamides such as nylon 6, nylon 6,6, nylon 4,6, nylon 8, nylon 6,10, nylon 11, and nylon 12, polyesters such as polyethyleneterephthalate (PET), and polybutadieneterephthalate (PBT) and polypropyleneterephthalate, polycarbonates, polyestercarbonates, styrene-containing polymers such as polystyrene, acrylonitrylstyrene polymers, acrylonitrile-butylacrylate-styrene polymers, acrylics, including polymethyl methacrylate, polyimides such as polyetherimide (PEI) and polyamideimide (PAI), polyphenylene ether, polyphenylene oxide, polyphenylenesulphide, polyethers, polyetherketones, polyacetals, polyurethanes, polybenzimidazole, and copolymers or mixtures thereof. In more particular aspects of the invention, the thermoplastic resin comprises a polyamide or a polyolefin selected from polyethylene, polypropylene, and copolymers or mixtures thereof. Other thermoplastic resins can be used that can be sufficiently softened by heat to permit the resin to at least partially impregnate the mat or fabric without being chemically or thermally decomposed during processing or formation of the sheet material. Such other suitable thermoplastic resins will generally be apparent to the skilled artisan.

Glass fibers suitable for use in the glass mat or fabric of the invention include fibers formed from E-glass, A-glass, C-glass, D-glass, R-glass, S-glass, or E-glass derivatives. Such glass fibers are known in the art. The term “E-glass derivatives” refers to glass compositions containing minor amounts of fluorine and/or boron, typically less than about 1 wt. % fluorine and less than about 5 wt. % boron, although desirably free fluorine and boron.

While not limited thereto, suitable mats and fabrics include chopped, random, and unidirectional glass fiber mats and fabrics and combinations thereof. Other suitable mats and fabrics as are known in the art may be used as well.

The glass fiber reinforced thermoplastic sheet material of the invention may further comprise additional fibers, including glass fibers, carbon fibers, synthetic organic fibers, particularly high modulus organic fibers such as para- and meta-aramid fibers, nylon fibers, polyester fibers, or any of the thermoplastic resins mentioned above that are suitable for use as fibers, natural fibers such as hemp, sisal, jute, and cellulosic fibers, mineral fibers such as basalt, mineral wool (e.g., rock or slag wool), wollastonite, alumina silica, and the like, or mixtures thereof, metal fibers, ceramic fibers, or mixtures thereof. While not specifically limited, the content of such fibers in the thermoplastic sheet material is generally from about 15% to about 65%, more particularly from about 45% to about 60%, by weight of the thermoplastic sheet material. Fibers suitable for use herein are described in the patent literature.

The thermoplastic sheet material of the invention may generally be used to form composite materials and articles prepared in various forms, such as sheets or films, as layered materials on pre-formed substrates, or in other more rigid forms depending on the particular application need. For certain applications, a composite material formed from the glass fiber reinforced thermoplastic sheet material may also be provided in sheet form, and may optionally include one or more additional layers on one or both surfaces of such a sheet. Without limitation, such surface or skin layers may be, e.g., a film, non-woven scrim, a veil, a woven fabric, or a combination thereof. The skin or surface layer may be desirably air permeable and may be able to substantially stretch and spread with the fiber-containing composite sheet during thermoforming and/or molding operations. In addition, such layers may be adhesive, such as a thermoplastic material (e.g., an ethylene acrylic acid copolymer or other such polymers) applied to the surface of the fiber-containing thermoplastic sheet material. Generally, the areal density of the composite material, particularly when in sheet form, generally varies from about 400 g/m² to about 5500 g/m², more particularly from about 400 g/m² to about 4000 g/m². In further aspects of the invention, the glass fiber reinforced thermoplastic sheet material may be utilized in a material in the form of a fiber-reinforced tape, such as a unidirectional tape.

The sheet material of the invention may be used to form various intermediate and final form articles, including construction articles, such as sandwich or ceiling panels, cargo liners, forms such as concrete forms, and office partitions, or articles for use in aerospace, marine and automotive applications, including, without limitation, a parcel shelf, package tray; headliner, door modules and panels, instrument panel topper, side wall, ceiling and flooring panels such as for recreational vehicles, cargo liners, front and/or rear pillar trim, a sunshade, and the like. Additional uses and articles include: battery trays and covers, bumper beams, compressor brackets, grill opening reinforcements, hvac bases and fan blades, load floors, noise and vibration shields and pads, wear pads, running boards, underbody panels, seat bases, skid plates, gas tank shields, spare wheel covers and wheel wells. In a particularly useful aspect of the invention, the sheet material may be used as the facesheet for various applications when lightweight and good mechanical performance are desired, such as in making sandwich panels with core materials made of foam, honeycomb, wood, or commercial sheet materials such as SUPERLITE® sheet made by Azdel Inc. (as described, e.g., in pending application Ser. No. 11/645,979, filed Dec. 26, 2006), and the like. The sheet material may also be utilized to form Class A substrate materials, such as interior/exterior door skins and skirt and exterior panels for vehicles. Other such articles will be apparent to the skilled artisan. Composite materials formed from the sheet material of the invention can be molded into various articles using methods known in the art, for example, pressure forming, thermal forming, thermal stamping, vacuum forming, compression forming, and autoclaving.

As described herein, the invention also relates to a method of providing a glass fiber reinforced thermoplastic sheet material having an improved combination of flexural strength and modulus and/or tensile strength and modulus properties. Generally, the method includes the steps of providing a first layer of a first thermoplastic resin and a second layer of a second thermoplastic resin; providing a layer of glass mat or glass fabric; arranging the first thermoplastic resin layer, the second thermoplastic resin layer and the glass mat or glass fabric layer such that the glass mat or glass fabric layer is interposed between the first and second thermoplastic resin layers, thereby forming a thermoplastic sheet material perform; applying heat to substantially melt the first thermoplastic resin and/or the second thermoplastic resin; applying pressure to compress the preform and at least partially impregnate the glass mat or glass fabric layer with the molten first thermoplastic resin and/or the molten second thermoplastic resin and to form a glass fiber reinforced thermoplastic sheet material having a thickness in the range of about 0.4 mm to about 3.0 mm.

Notably, the method provides a sheet material having an improved combination of flexural strength and modulus and/or tensile strength and modulus properties at reduced basis weight compared to a comparative glass fiber reinforced thermoplastic sheet material differing from the inventive sheet material in that the sheet thickness is greater than about 3.0 mm. In one embodiment of the invention, the comparative glass fiber reinforced thermoplastic sheet material has a thickness in the range of about 3.5 mm to about 4.6 mm and a basis weight in the range of about 3500 gsm to about 5500 gsm.

It should be noted that while the method provides an improved combination of flexural and tensile properties, it is not necessary that all such characteristics be individually improved relative to a comparative sheet material. While improvement in each of these characteristics is certainly desirable, for the purposes described herein, an improvement may be said to result if one, more than one, or all of such flexural and tensile properties is or are improved relative to the comparative sheet material.

The method of the invention may be practiced as a batch or a continuous process. For example, the sheet material may be formed by arranging one or more glass mat or fabric layers between layers of thermoplastic resin in a mold and subjecting the mold and sheet material components to a compression molding operation. Similarly, a continuous process may be used to form the sheet material, such as by extruding two or more layers of thermoplastic resin and combining the extrudate layers with one or more layers of glass mat or fabric interposed between the thermoplastic resin layers. Both methods may be used to produce sheet materials having three or more plys of resin and glass mat or fabric. In a more particular embodiment, the first thermoplastic resin and the second thermoplastic resin are heated to substantially melt the resins and extruded to form molten layers of the first thermoplastic resin and the second thermoplastic resin, the glass mat or glass fabric layer is interposed between the molten layers thereby forming the thermoplastic sheet material perform, and the preform is compressed between one or more consolidation devices, such as laminating rollers, to form the glass fiber reinforced thermoplastic sheet material. In general, suitable consolidation devices may be, e.g., calendaring rolls, double belt laminators, indexing presses, multiple daylight presses, autoclaves, and other such devices used for lamination and consolidation of sheets and fabrics so that the plastic material can flow and wet out the fibers of the mat or fabric. The gap between the consolidating elements in the consolidation devices may be set to a dimension less than that of the unconsolidated thermoplastic sheet material and greater than that of the sheet material if it were to be fully consolidated. Additional steps may also be utilized in the inventive method, such as the inclusion of appropriate steps to provide one or more surface or skin layers to the sheet material.

It should also be noted that the method of the invention is not necessarily limited to the recited steps, or a particular order or sequence of carrying out those steps. For example, when an extrusion process is employed to laminate two or more layers of molten thermoplastic to one or more layer(s) of glass mat or fabric, the thermoplastic resins are typically heated and extruded, contacted with the glass mat or fabric, and then passed through laminating rollers to form the glass fiber reinforced thermoplastic sheet material. For other suitable processes, the ordering of heating and/or use of pressure steps may be different than the above-described extrusion process.

The glass fiber reinforced thermoplastic sheet material may be desirably formed into an article by a forming technique such as compression molding or thermoforming, using air or gas pressure as an assist, if desired. Such methods are well known and described in the literature, e.g., see U.S. Pat. Nos. 6,923,494 and 5,601,679. Thermoforming methods and tools are also described in detail in DuBois and Pribble's “Plastics Mold Engineering Handbook”, Fifth Edition, 1995, pages 468 to 498.

Additional information concerning suitable thermoplastic resins fibers and other additives, as well as details concerning manufacturing methods useful in the present invention, may be found in U.S. Pat. Nos. 5,981,046, 6,756,099. Although not specifically mentioned herein, the thermoplastic sheet materials may include conventional additives, such as stabilizers, fillers, colorants, flame retardants, and the like without limitation.

It is to be understood that while the invention has been described in conjunction with certain specific embodiments thereof, that the foregoing description as well as the examples that follow are intended to illustrate and not limit the scope of the invention. Other aspects, advantages and modifications within the scope of the invention will be apparent to those skilled in the art to which the invention pertains.

All patents, patent applications, provisional patent applications, and publications mentioned herein are hereby incorporated by reference in their entireties.

### EXPERIMENTAL

Glass fiber reinforced thermoplastic sheets were prepared using an extrusion process (as described and referenced herein) in which chopped E-glass fiber mats were laminated between layers of polypropylene resin. Representative inventive glass fiber reinforced three ply sheets were prepared having a thickness of 1.06 mm with a single layer of E-glass fiber mat sandwiched between two layers of polypropylene. Comparative glass fiber reinforced sample sheets having a thickness of 3.61 mm and a five ply construction (two layers of glass mat interposed with layers of polypropylene) were also prepared.

The glass fiber reinforced thermoplastic sheets were prepared by extruding the resin layers and arranging the layers of molten resin and fabric such that either a three ply of five ply construction was formed. The sheets were laminated using a double belt laminator having a hot zone and a cold zone. The contact time of the sheet material in the laminator hot zone was sufficient to allow the molten resin to penetrate the glass fiber mat.

Sample specimens were evaluated for flexural properties including flexural strength and modulus and tensile strength and modulus at particular glass fiber mat contents and sheet thicknesses. Samples were also prepared for Multiaxial impact testing according to ASTM D3762.

After the sheet samples were prepared, flex bars (e.g., 2.0 in.×0.5 in. samples, or other dimensions as required by ASTM or ISO test protocols) were cut out and tested according to the ASTM D790 three-point bending test method, or according to the ISO 178 test method. The specimens were supported for loading by placing them on supports spaced as required by the ASTM or ISO test and were loaded at a constant crosshead speed at the centerpoint of the specimen according to the ASTM or ISO testing protocol. The stress/strain data were recorded as the load was applied, along with the peak load at break. The flexural modulus was determined as the slope from the linear portion of the stress/strain curve in a conventional manner. The data were then evaluated to determine the average values of flexural strength and modulus. Tensile characteristics were evaluated to determine the tensile strength and modulus in a conventional manner according to ASTM D638 test procedures for Type I specimens, or according to ISO 527.

### Example 1 and Comparative Example 1A Flexural and Tensile Properties

Glass fiber reinforced thermoplastic sheet samples were prepared as described above containing E-glass fiber mat impregnated with a polypropylene resin. Three ply sheet samples according to the invention were prepared at a thickness of 1.06 mm in which a single layer of E-glass fiber mat was laminated between two layers of polypropylene. Comparative sheet samples were also prepared as described above containing E-glass fiber mat impregnated with polypropylene resin at a thickness of 3.61 mm. Due in part to the thickness, the comparative sheet samples were five ply constructions in which two layers of glass mat were laminated between three layers of polypropylene resin, with each layer of glass mat interposed between two polypropylene layers and one of the polypropylene layers forming a central layer between the mat layers. The total gsm values for the glass-filled sheets were 1184 gsm for the inventive three ply sheets and 4000 gsm for the five ply comparative sheets.

The flexural and tensile properties (strength and modulus) of the glass fiber reinforced sheets were evaluated and are shown in Table 1 as averages for each of the sheet samples.

TABLE 1

| Parameter | Example 1 | Example 1A |
|---|---|---|
| Glass Content (wt. %) | 38.9 | 32 |
| Basis Weight, (g/m²) | 1184 | 4000 |
| Specific Gravity (g/cm³) | 1.1 | 1.12 |
| Thickness (mm) | 1.06 | 3.61 |
| Tensile Strength (MPa) | 92 | 82 |
| Tensile Modulus (GPa) | 5.71 | 4.62 |
| Flexural Srength (MPa) | 150 | 120 |
| Flexural Modulus (GPa) | 6.42 | 4.38 |

From Table 1, it should be noted that Example 1 shows tensile strength and modulus values that are respectively about 12% and 24% higher than the comparative thermoplastic sheet of Example 1A. Similarly, the flexural strength and modulus values of Example 1 are respectively about 25% and 47% higher than the comparative thermoplastic sheet of Example 1A. As is also shown, these tensile and flexural properties are exhibited at a reduced basis weight of 1184 gsm compared to 4000 gsm for comparative Example 1A, representing a basis weight decrease of about 70%.

### Example 2

### Flexural Property Evaluation

Additional flexural results were obtained in order to determine the effects and results for laminates having thicknesses in the range of about 1-5 mm. Laminate samples and test specimens were prepared as described in the general experimental section and in Example 1. Laminate and specimen characteristics for tested specimens are shown in Table 2.

TABLE 2
GMT Laminate Sample Specimen Characteristics

| | | | | | | Fiber | |
|---|---|---|---|---|---|---|---|
| Speci- | | | Basis | Glass | Laminate | Mat | No. |
| men | Thickness | | Weight | Content | Density¹ | Content | Mat |
| No. | (mm) | (mils) | (gsm) | (%) | (g/cm³) | (oz) | Layers |
| 1 | 1.24 | 49 | 1210 | 37.7 | 1.01 | 1.6 | 1 |
| 2 | 1.32 | 52 | 1229 | 35.7 | 0.94 | 1.6 | 1 |
| 3 | 2.23 | 88 | 2224 | 37.4 | 1.00 | 2.82 | 1 |
| 4 | 3.86 | 152 | 4161 | 41.2 | 1.08 | 2.82 | 2 |
| 5 | 4.63 | 182 | 5190 | 39.6 | 1.13 | 3.5 | 2 |
| 6² | 4.00 | 157 | 4830 | 40.0 | 1.19 | 2.88 | 2 |

¹ASTM D792
²GMT molded sheet specimen: a five layer GMT made from two chopped fiber mats and three resin layer extrudates as described in the general experimental section and in Example 1.

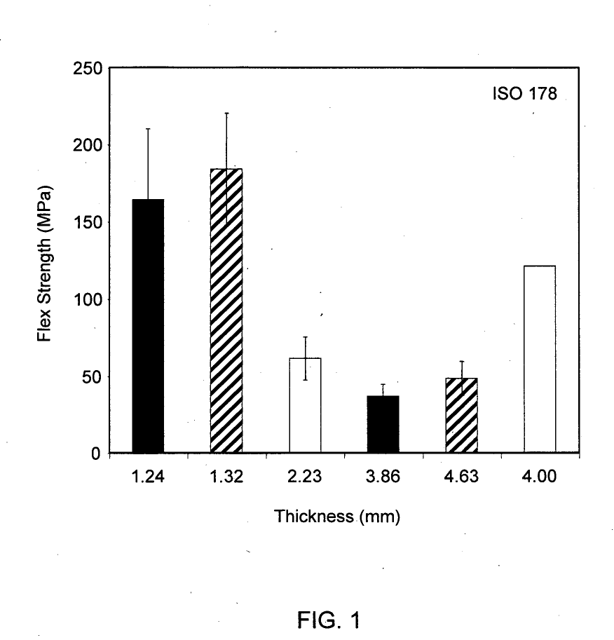

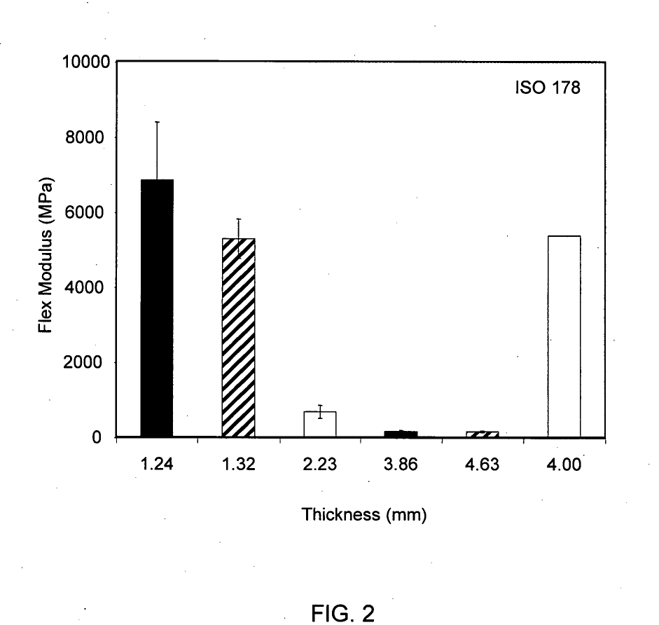

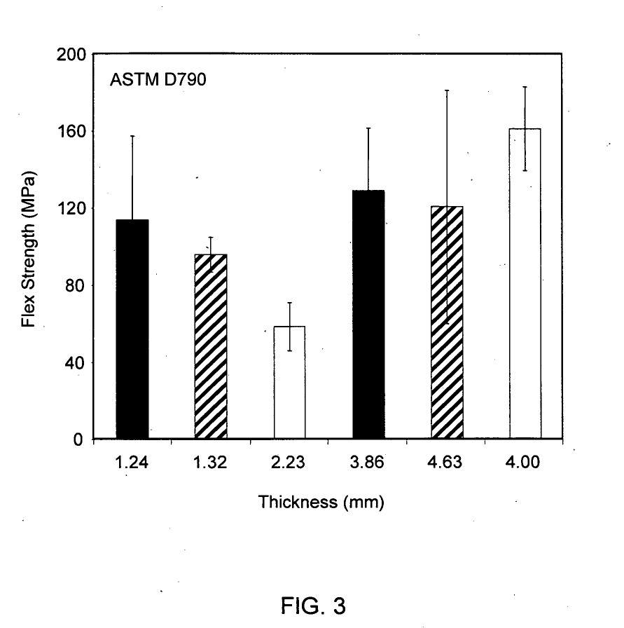

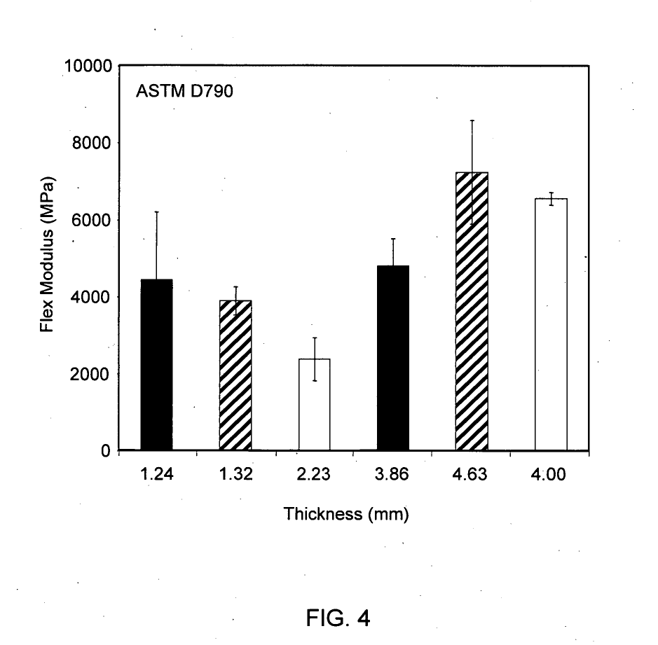

Results for flexural testing of the specimens listed in Table 1 according to ASTM D790 and ISO 178 are reported in Table 3 and shown in FIGS. 1-4.

TABLE 3
GMT Laminate Specimen Flexural Test Results

| | | | Flexural | | Flexural | |
|---|---|---|---|---|---|---|
| | | | Strength | | Modulus | |
| | | Basis | (MPa) | | (MPa) | |
| Specimen | Thickness | Weight | ASTM | ISO | ASTM | ISO |
| No. | (mm) | (gsm) | D790 | 178 | D790 | 178 |
| 1 | 1.24 | 1210 | 114 | 164 | 4447 | 6844 |
| 2 | 1.32 | 1229 | 96 | 184 | 3889 | 5288 |
| 3 | 2.23 | 2224 | 58 | 61 | 2373 | 680 |
| 4 | 3.86 | 4161 | 129 | 37 | 4812 | 153 |
| 5 | 4.63 | 5190 | 121 | 48 | 7245 | 151 |
| 6 | 4.00 | 4830 | 162 | 121 | 6553 | 5368 |

From the flexural results shown in Table 3 and FIGS. 1-4, it can be noted that specimens having thicknesses of about 2.2 mm or less showed improved flexural properties as determined according to ISO 178 when compared against specimens having greater thicknesses.

### Example 3

### Tensile Property Evaluation

Additional tensile results were obtained in order to determine the effects and results for laminates having thicknesses in the range of about 1-5 mm. Laminate samples and test specimens were prepared as described in the general experimental section and in Example 1. Laminate and specimen characteristics for tested specimens are shown in Table 2.

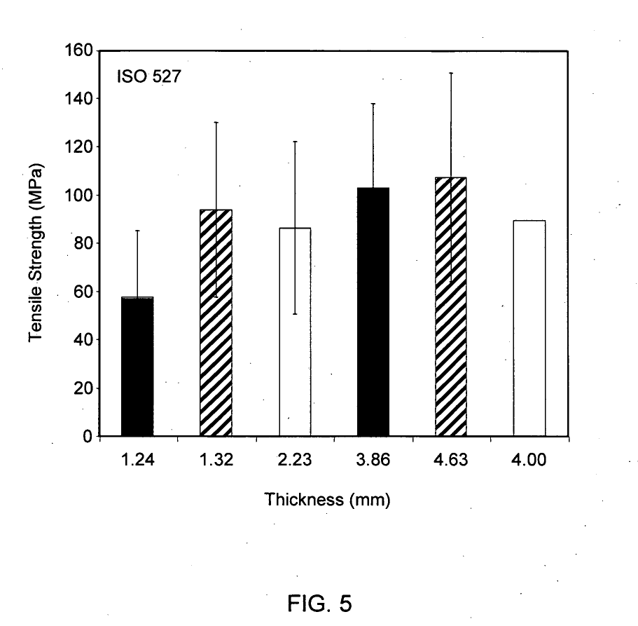

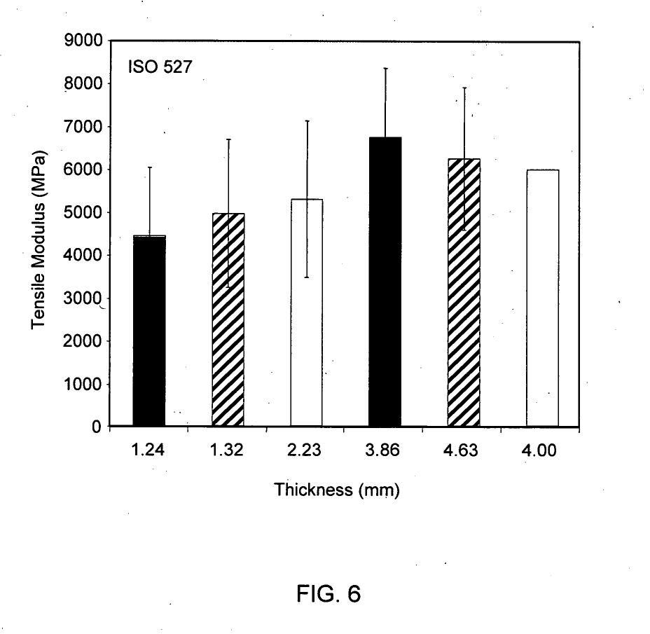

Results for tensile testing of the specimens listed in Table 1 according to ISO 527 ate reported in Table 4 and shown in FIGS. 5-6.

TABLE 4
GMT Laminate Specimen Tensile Test Results¹

| | | Basis | Tensile | Tensile | Tensile |
|---|---|---|---|---|---|
| Specimen | Thickness | Weight | Strength | Modulus | Elongation |
| No. | (mm) | (gsm) | (MPa) | (MPa) | (%) |
| 1 | 1.24 | 1210 | 58 | 4403 | 1.8 |
| 2 | 1.32 | 1229 | 95 | 4933 | 3.1 |
| 3 | 2.23 | 2224 | 87 | 5266 | 2.3 |
| 4 | 3.86 | 4161 | 104 | 6714 | 2.3 |
| 5 | 4.63 | 5190 | 108 | 6219 | 2.5 |
| 6 | 4.00 | 4830 | 90 | 5965 | 2.2 |

¹ISO 527

From the tensile results shown in Table 4 and FIGS. 5-6, it can be noted that specimens having thicknesses of about 2.2 mm or less showed comparable tensile properties when compared against specimens having greater thicknesses.

### Example 4

### Impact Property Evaluation

Additional impact results were obtained in order to determine the effects and results for laminates having thicknesses in the range of about 1-5 mm. Laminate samples and test specimens were prepared as described in the general experimental section and in Example 1. Laminate and specimen characteristics for tested specimens are shown in Table 2.

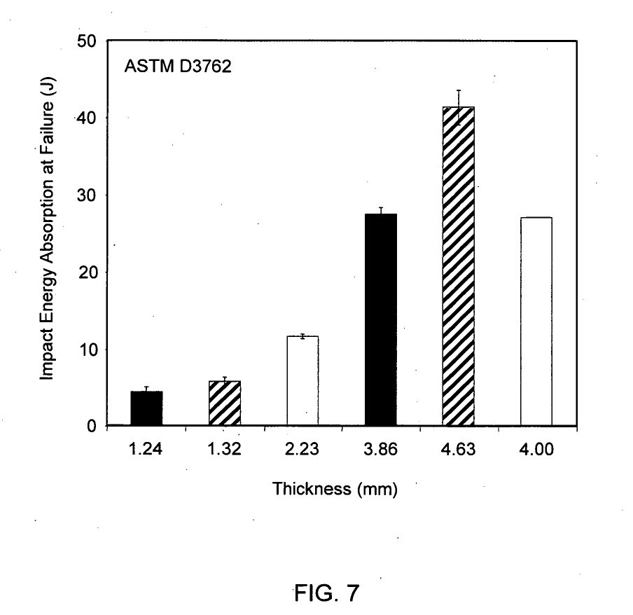

Results for Multiaxial impact testing of the specimens listed in Table 1 according to ASTM D3762 are reported in Table 5 and shown in FIG. 7.

TABLE 5
GMT Laminate Specimen Impact Test Results

| | | | Multiaxial Impact¹ | | |
|---|---|---|---|---|---|
| | | Basis | Peak | Peak | Failure |
| Specimen | Thickness | Weight | Load | Energy | Energy |
| No. | (mm) | (gsm) | (N) | (J) | (J) |
| 1 | 1.24 | 1210 | 677 | 1.4 | 4.5 |
| 2 | 1.32 | 1229 | 762 | 1.9 | 5.7 |
| 3 | 2.23 | 2224 | 1427 | 4.5 | 11.6 |
| 4 | 3.86 | 4161 | 3338 | 13.3 | 27.4 |
| 5 | 4.63 | 5190 | 4478 | 18.9 | 41.3 |
| 6 | 4.00 | 4830 | 2489 | 10.0 | 27.0 |

¹ASTM D3762

From the impact results shown in Table 5 and FIG. 7, it can be noted that specimens having thicknesses of about 2.2 mm or less showed reduced impact energy absorption at failure when compared against specimens having greater thicknesses. While not necessarily limited thereto, the reduced thickness of specimens 1-3 and the additional mat layer of specimens 4-6 likely account for at least some of the differences in the observed results.

While the invention has been described in terms of various specific embodiments, those skilled in the art will recognize that the invention can be practiced with modification within the spirit and scope of the disclosure.

What is claimed is:

1. A glass fiber reinforced thermoplastic sheet material comprising
a thermoplastic resin and
glass mat or glass fabric impregnated with the thermoplastic resin in an amount of about 15 wt. % to about 65 wt. % of the glass fiber reinforced thermoplastic sheet material,
wherein, the glass fiber reinforced thermoplastic sheet material has a thickness in the range of about 0.4 mm to about 3.0 mm and exhibits greater flexural and/or tensile strength and modulus properties at reduced basis weight compared to a comparative glass fiber reinforced thermoplastic sheet material having a thickness of greater than about 3.0 mm.

2. The glass fiber reinforced thermoplastic sheet material of claim 1, wherein the glass fiber reinforced thermoplastic sheet material has a thickness in the range of about 0.4 mm to about 2.2 mm.

3. The glass fiber reinforced thermoplastic sheet material of claim 2, wherein the sheet thickness is in the range of about 0.8 mm to about 2.2 mm.

4. The glass fiber reinforced thermoplastic sheet material of claim 1, wherein the glass fiber reinforced thermoplastic sheet material exhibits flexural strength and flexural modulus properties that are each at least about 10% greater than the comparative glass fiber reinforced thermoplastic sheet material.

5. The glass fiber reinforced thermoplastic sheet material of claim 4, wherein the glass fiber reinforced thermoplastic sheet material exhibits flexural strength and flexural modulus properties that are each at least about 20% greater than the comparative glass fiber reinforced thermoplastic sheet material.

6. The glass fiber reinforced thermoplastic sheet material of claim 1, wherein the glass fiber reinforced thermoplastic sheet material exhibits tensile strength and tensile modulus properties that are each comparable to or greater than the comparative glass fiber reinforced thermoplastic sheet material.

7. The glass fiber reinforced thermoplastic sheet material of claim 1, wherein the reduced basis weight of the glass fiber reinforced thermoplastic sheet material is at least about 50% less than the comparative glass fiber reinforced thermoplastic sheet material.

8. The glass fiber reinforced thermoplastic sheet material of claim 1, wherein the comparative glass fiber reinforced thermoplastic sheet material has a thickness in the range of about 3.5 mm to about 4.6 mm and a basis weight in the range of about 3500 gsm to about 5500 gsm.

9. The glass fiber reinforced thermoplastic sheet material of claim 1, wherein the glass content of the glass mat or glass fabric dispersed within the thermoplastic resin is in the range of about 30 wt. % to about 50 wt. % of the glass fiber reinforced thermoplastic sheet material.

10. The glass fiber reinforced thermoplastic sheet material of claim 1, wherein the thermoplastic resin is selected from polyolefins, thermoplastic polyolefin blends, polyvinyl polymers, butadiene polymers, acrylic polymers, polyamides, polyesters, polycarbonates, polyestercarbonates, polystyrenes, acrylonitrylstyrene polymers, acrylonitrile-butylacrylate-styrene polymers, polyimides, polyphenylene ether, polyphenylene oxide, polyphenylenesulphide, polyethers, polyetherketones, polyacetals, polyurethanes, polybenzimidazole, and copolymers or mixtures thereof.

11. The glass fiber reinforced thermoplastic sheet material of claim 10, wherein the thermoplastic resin comprises a polyamide or a polyolefin selected from polyethylene, polypropylene, and copolymers or mixtures thereof.

12. The glass fiber reinforced thermoplastic sheet material of claim 1, wherein the glass mat or glass fabric comprises glass fibers selected from E-glass, A-glass, C-glass, D-glass, R-glass, S-glass, or E-glass derivatives.

13. The glass fiber reinforced thermoplastic sheet material of claim 1, further comprising fibers selected from glass fibers, carbon fibers, synthetic organic fibers, natural fibers, mineral fibers, metal fibers, ceramic fibers, or a combination thereof.

14. The glass fiber reinforced thermoplastic sheet material of claim 1, further comprising a skin layer selected from films, non-woven scrims, veils, woven fabrics, or a combination thereof.

15. A glass fiber reinforced thermoplastic composite comprising the glass fiber reinforced thermoplastic sheet material of claim 1.

16. An article formed from the glass fiber reinforced thermoplastic sheet material of claim 1, in the form of a sandwich panel, construction article, tape, or an automobile article selected from a parcel shelf, package tray, headliner, door module, panel, skin and skirt, instrument panel topper, side wall, ceiling and flooring panel, cargo liner, front and/or rear pillar trims, sunshade, battery trays and covers, bumper beams, compressor brackets, grill opening reinforcements, hvac bases and fan blades, load floors, noise and vibration shields and pads, wear pads, running boards, underbody panels, seat bases, skid plates, gas tank shields, wheel covers and wheel wells or a facesheet material.

17. The glass fiber reinforced thermoplastic sheet material of claim 1, prepared by a method of providing a sheet material comprising, providing a first layer of a first thermoplastic resin and a second layer of a second thermoplastic resin,
providing a layer of glass mat or glass fabric, arranging the first thermoplastic resin layer, the second thermoplastic resin layer and the glass mat or glass fabric layer such that the glass mat or glass fabric layer is interposed between the first and second thermoplastic resin layers, thereby forming a thermoplastic sheet material preform,
applying heat to substantially melt the first thermoplastic resin and/or the second thermoplastic resin,
applying pressure to compress the preform and at least partially impregnate the glass mat or glass fabric layer with the molten first thermoplastic resin and/or the molten second thermoplastic resin and to form the glass fiber reinforced thermoplastic sheet material.

18. The glass fiber reinforced thermoplastic sheet material of claim 17, wherein the first thermoplastic resin and the second thermoplastic resin are heated to substantially melt the resins and extruded to form molten layers of the first thermoplastic resin and the second thermoplastic resin, the glass mat or glass fabric layer is interposed between the molten layers thereby forming the thermoplastic sheet material preform, and the preform is compressed between laminating rollers to form the glass fiber reinforced thermoplastic sheet material.

19. In a glass fiber reinforced thermoplastic sheet material comprising a thermoplastic resin and glass mat or glass fabric impregnated with the thermoplastic resin, the improvement comprising providing improved flexural and/or tensile strength and modulus properties at reduced basis weight by forming the sheet material at a thickness in the range of about 0.4 mm to about 3.0 mm, compared to a comparative glass fiber reinforced thermoplastic sheet material having a thickness of greater than about 3.0 mm.

20. The glass fiber reinforced thermoplastic sheet material of claim 19, wherein the glass fiber reinforced thermoplastic sheet material exhibits flexural strength and modulus and/or tensile strength and modulus properties that are each at least about 10% greater than the comparative glass fiber reinforced thermoplastic sheet material.

21. The glass fiber reinforced thermoplastic sheet material of claim 19, wherein the reduced basis weight of the glass fiber reinforced thermoplastic sheet material is at least about 50% less than the comparative glass fiber reinforced thermoplastic sheet material.

22. A method of providing a glass fiber reinforced thermoplastic sheet material having an improved combination of flexural strength and modulus and/or tensile strength and modulus properties, the method comprising,
providing a first layer of a first thermoplastic resin and a second layer of a second thermoplastic resin,
providing a layer of glass mat or glass fabric, arranging the first thermoplastic resin layer, the second thermoplastic resin layer and the glass mat or glass fabric layer such that the glass mat or glass fabric layer is interposed between the first and second thermoplastic resin layers, thereby forming a thermoplastic sheet material preform,
applying heat to substantially melt the first thermoplastic resin and/or the second thermoplastic resin,
applying pressure to compress the preform and at least partially impregnate the glass mat or glass fabric layer with the molten first thermoplastic resin and/or the molten second thermoplastic resin and to form the glass fiber reinforced thermoplastic sheet material, wherein, the glass fiber reinforced thermoplastic sheet material has a thickness in the range of about 0.4 mm to about 3.0 mm and exhibits greater flexural and/or tensile strength and modulus properties at reduced basis weight compared to a comparative glass fiber reinforced thermoplastic sheet material having a thickness of greater than about 3.0 mm.

23. The method of claim 22, wherein the first thermoplastic resin and the second thermoplastic resin are heated to substantially melt the resins and extruded to form molten layers of the first thermoplastic resin and the second thermoplastic resin, the glass mat or glass fabric layer is interposed between the molten layers thereby forming the thermoplastic sheet material perform, and the perform is compressed between laminating rollers to form the glass fiber reinforced thermoplastic sheet material.

24. The method of claim 22, wherein the glass fiber reinforced thermoplastic sheet material exhibits flexural strength and modulus and/or tensile strength and modulus properties that are each at least about 10% greater than the comparative glass fiber reinforced thermoplastic sheet material.

25. The method of claim 22, wherein the reduced basis weight of the glass fiber reinforced thermoplastic sheet material is at least about 50% less than the comparative glass fiber reinforced thermoplastic sheet material.

26. A glass fiber reinforced thermoplastic sheet material prepared by the method of claim 22.

27. A glass fiber reinforced thermoplastic composite prepared from the glass fiber reinforced thermoplastic sheet material of claim 26.

28. An article formed from the sheet material of claim 26, in the form of a sandwich panel, construction article, tape, or an automobile article selected from a parcel shelf, package tray, headliner, door module, panel, skin and skirt, instrument panel topper, side wall, ceiling and flooring panel, cargo liner, front and/or rear pillar trims, sunshade, battery trays and covers, bumper beams, compressor brackets, grill opening reinforcements, hvac bases and fan blades, load floors, noise and vibration shields and pads, wear pads, running boards, underbody panels, seat bases, skid plates, gas tank shields, wheel covers and wheel wells or a facesheet material.
